(19) United States
(12) Patent Application Publication
(10) Pub. No.: US 2011/0146942 A1
(43) Pub. Date: Jun. 23, 2011

(54) Distribution Unit For A Refrigerating Fluid Circulating Inside An Air Conditioning Loop And An Air Conditioning Loop Comprising Such A Distribution Unit

(76) Inventors: Klaus WITTMANN, Le Mesnil Saint Denis (FR); Mohamed YAHIA, Paris (FR); Bertrand NICOLAS, Elancourt (FR)

(21) Appl. No.: 12/968,391

(22) Filed: Dec. 15, 2010

(30) Foreign Application Priority Data
Dec. 17, 2009 (FR) FR09/06130

(51) Int. Cl. B60H 1/22; B60H 1/32

(52) U.S. Cl. 165/42; 62/525

(57) ABSTRACT

The invention relates to a distribution unit (22) that is able to manage the circulation of a cooling fluid FR in an A/C loop (4). The distribution unit (22) comprises nine inlets E₁, E₂, E₃, E₄, E₅, E₆, E₇, E₈, E₉ of the cooling fluid FR inside the distribution unit (22) and four outlets S₁, S₂, S₃, S₄ of the cooling fluid FR outside the distribution unit (22). Each outlet S₁, S₂, S₃, S₄ is linked with at least two inlets E₁, E₂, E₃, E₄, E₅, E₆, E₇, E₈, E₉.

### TECHNICAL FIELD OF THE INVENTION

The invention lies in the field of ventilation, heating and/or air conditioning installations for motor vehicles. The subject thereof is a distribution unit suitable for managing the circulation of a refrigerating fluid within an air conditioning loop. Another subject is such an air conditioning loop comprising said distribution unit.

### PRIOR ART

A motor vehicle is usually equipped with an air conditioning system for modifying the aerothermal parameters of the air contained inside the vehicle cabin. Such a modification is obtained from the delivery of an internal air flow in the cabin. The air conditioning system comprises a ventilation, heating and/or air conditioning installation that channels the circulation of the internal air flow prior to the delivery thereof in the cabin. The installation consists of a housing produced from plastics material and housed under a dashboard of the vehicle.

To modify a temperature of the internal air flow prior to the discharge thereof out of the housing to the cabin, the air conditioning system comprises an air conditioning loop within which a refrigerating fluid circulates, such as carbon dioxide known as R744. The air conditioning loop comprises a plurality of elements such as a compressor for raising the refrigerating fluid to a high pressure and an accumulator for preventing an admission of refrigerating fluid in the liquid state within the compressor. The air conditioning loop also comprises refrigerating fluid/internal air heat exchangers for successive heat transfers between the refrigerating fluid and the internal air flow. The internal air/refrigerating fluid heat exchangers are placed inside the installation so as to have the internal air flow pass through them prior to the discharge of the latter out of the housing to the cabin. The air conditioning loop also comprises a pressure reduction member interposed between the refrigerating fluid/internal air heat exchangers, the pressure reduction member being designed to reduce the pressure of refrigerating fluid within the air conditioning loop. The latter also comprises a refrigerating fluid/ambient air heat exchanger to allow a transfer of heat between the refrigerating fluid and a flow of ambient air. The refrigerating fluid/ambient air heat exchanger is for example placed at the front of the vehicle in order to facilitate heat transfer between the refrigerating fluid and the ambient air flow, such as an air flow external to the vehicle. The air conditioning loop finally comprises a distribution unit for managing the circulation of refrigerating fluid between the various aforementioned elements. Reference can for example be made to the document JP6239131 (Nippon Denso Co), which describes such an air conditioning system.

The distribution unit is able to make the air conditioning loop function in heating mode or in air conditioning mode. In heating mode, the air conditioning loop affords heating of the internal air while in air conditioning mode the air conditioning loop is able to cool it. The change in functioning of the air conditioning loop between these two modes is obtained from a modification of the circulation of the refrigerating fluid inside the distribution unit between various ports that the latter has. The ports are either refrigerating fluid inlets to the inside of the distribution unit, or refrigerating unit outlets out of the distribution unit.

More particularly, the distribution unit comprises a port A connected to an output of the compressor and a port B connected to an input of the accumulator. The distribution unit also comprises a port C connected to an input/output of the refrigerating fluid/ambient air heat exchanger and a port D connected to another input/output of the refrigerating fluid/ambient air heat exchanger. Finally, the distribution unit also comprises a port E connected to an input/output of the first refrigerating fluid/internal air heat exchanger and a port F connected to an input/output of the second refrigerating fluid/internal air heat exchanger.

In heating mode, the refrigerating fluid flows from port A to port F through a first channel in the distribution unit, and then circulates inside the second refrigerating fluid/internal air heat exchanger, then inside the pressure reduction member, then inside the first refrigerating fluid/internal air heat exchanger, then follows a second channel in the distribution unit that extends between port E and port D, then inside the refrigerating fluid/ambient air heat exchanger, then follows a third channel in the distribution unit that extends between port C and port B, and then circulates inside the accumulator in order to return to the compressor.

In air conditioning mode, the refrigerating fluid flows from port A to port C by means of a fourth channel in the distribution unit, then circulates inside the refrigerating fluid/ambient air heat exchanger, then follows a fifth channel in the distribution unit that extends between port D and port F, then circulates inside the second refrigerating fluid/internal air heat exchanger, then inside the pressure reduction member, then inside the first refrigerating fluid/internal air heat exchanger, then follows a sixth channel in the distribution unit that extends between port E and port B, and then inside the accumulator in order to return to the compressor.

The first, second, third, fourth, fifth and sixth channels are obtained from the rotation of a cylinder provided with three passages inside a sleeve equipped with said ports.

One problem posed by the use of the distribution unit according to JP6239131 lies in the fact that it is not able to manage the circulation of the refrigerating fluid between the various elements of the air conditioning loop simply and effectively. More particularly, the fact that some ports in the distribution unit are alternately refrigerating fluid inlets and outlets is a source of malfunctioning. More particularly again, such a distribution unit is liable to present risks of leakage of refrigerating fluid, which it is preferable to avoid. Finally, such a distribution unit is not arranged to allow functioning of the air conditioning loop in an internal air flow dehumidification mode.

### Subject Matter of the Invention

The aim of the present invention is to propose a distribution unit that is able to simply manage the circulation of a refrigerating fluid FR within an air conditioning loop, the latter consisting of an air conditioning system of a motor vehicle, the distribution unit being in a position to effectively determine the routing of the refrigerating fluid FR between various elements making up the air conditioning loop, while minimising the risks of leakage of the refrigerating fluid FR out of the air conditioning loop. Another aim of the present invention is to propose such a distribution unit that enables the air conditioning system to function in various modes, heating mode, air conditioning mode and dehumidification mode in particular, and is in a position to make changes from one mode to another mode in a simple and reliable manner.

A distribution unit of the present invention is a distribution unit able to manage the circulation of a refrigerating fluid FR within an air conditioning loop. The distribution unit comprises a plurality of inlets E₁, E₂, E₃, E₄, E₅, E₆, E₇, E₈, E₉ for refrigerating fluid FR to the inside of the distribution unit and a plurality of outlets S₁, S₂, S₃, S₄ for refrigerating fluid FR out of the distribution unit. Each outlet S₄, S₂, S₃, S₄ is in fluid connection with at least two inlets E₁, E₂, E₃, E₄, E₅, E₆, E₇, E₈, E₉.

The distribution unit preferentially comprises nine inlets E₁, E₂, E₃, E₄, E₅, E₆, E₇, E₈, E₉ and four outlets S₁, S₂, S₃, S₄.

A first outlet S₁ is advantageously in fluid connection with the first inlet E₁ and a second inlet E₂.

The first outlet S₁ is advantageously in fluid connection with the first inlet E₁ by means of a first channel C₁, which is provided with a first pressure reduction member D₁.

The first pressure reduction member D₁ is preferentially an electronically controlled pressure reduction device.

The first channel C₁ is for example equipped with a first valve V′₁.

The first output S₁ is advantageously in fluid connection with the second inlet E₂ by means of a second channel C₂, which is provided with a first shutter V₁.

Preferably, the first outlet S₁, the first inlet E₁, the second inlet E₂, the first channel C₁, the second channel C₂, the first shutter V₁, the first valve V′₁ and the first pressure reduction member D₁ constitute a first subassembly SE₁.

A second output S₂ is advantageously in fluid connection with a third input E₃ and a fourth input E₄.

The second output S₂ is advantageously in fluid connection with the third inlet E₃ by means of a third channel C₃, which is provided with a second pressure reduction member D₂.

The second pressure reduction member D₂ is preferentially an electronically controlled pressure reduction device.

The third channel C₃ is for example equipped with a second valve V′₂.

The second outlet S₂ is advantageously in fluid connection with the fourth inlet E₄ by means of a fourth channel C₄, which is provided with a second shutter V₂.

Preferably, the second outlet S₂, the third inlet E₃, the fourth inlet E₄, the third channel C₃, the fourth channel C₄, the second valve V′₂, the second shutter V₂ and the second pressure reduction member D₂ constitute a second subassembly SE₂.

A third outlet S₃ is advantageously in fluid connection with a fifth inlet E₅, a sixth inlet E₆ and a seventh inlet E₇.

The third outlet S₃ is advantageously in fluid connection with the fifth inlet E₅ by means of a fifth channel C₅, which is provided with a third shutter V₃.

The third outlet S₃ is advantageously in fluid connection with the sixth inlet E₆ by means of a sixth channel C₆, which is provided with a fourth shutter V₄.

The third outlet S₃ is advantageously in fluid connection with the seventh inlet E₇ by means of a seventh channel C₇, which is provided with a fifth shutter V₅.

Preferably, the third outlet S₃, the fifth inlet E₅, the sixth inlet E₆, the seventh inlet E₇, the fifth channel C₅, the sixth channel C₆, the seventh channel C₇, the third shutter V₃, the fourth shutter V₄ and the fifth shutter V₅ constitute a third subassembly SE₂.

A fourth outlet S₄ is advantageously in fluid connection with an eighth inlet E₈ and a ninth inlet E₉.

The fourth outlet S₄ is advantageously in fluid connection with the eighth inlet E₈ by means of an eighth channel C₉, which is provided with a sixth shutter V₆.

The fourth outlet S₄ is advantageously in fluid connection with the ninth inlet E₉ by means of a ninth channel C₉, which is provided with a third pressure reduction member D₃.

The third pressure reduction member D₃ is for example an electronically controlled pressure reduction device.

The ninth channel C₉ is preferentially equipped with a third valve V′₃.

A seventh shutter V₇ is advantageously disposed in parallel to the third pressure reduction member D₃ and the third valve V′₃.

Preferably, the fourth outlet S₄, the eighth inlet E₈, the ninth inlet E₉, the eighth channel C₈, the ninth channel C₉, the sixth shutter V₆, the seventh shutter V₇, the third valve V′₃ and the third pressure reduction member D₃ constitute a fourth subassembly SE₄.

Such a distribution unit is advantageously used for managing the circulation of the refrigerating fluid FR within the air conditioning loop.

An air conditioning loop of the present invention is mainly recognisable in that the air conditioning loop comprises such a distribution unit.

The air conditioning loop advantageously comprises a refrigerating fluid/heat transfer fluid heat exchanger, a refrigerating fluid/heat transfer liquid heat exchanger, a refrigerating fluid/ambient air heat exchanger, an internal heat exchanger and a compressor associated with an accumulator.

The refrigerating fluid/ambient air heat exchanger advantageously comprises a discharge orifice for refrigerating fluid FR that is in fluid connection with the seventh inlet E₇ and the eighth inlet E₈.

The refrigerating fluid/ambient air heat exchanger advantageously comprises an admission orifice for refrigerating fluid FR that is in fluid connection with the first outlet S₁.

The refrigerating fluid/heat transfer liquid heat exchanger advantageously comprises an outlet orifice for refrigerating fluid FR that is in fluid connection with the sixth inlet E₆ and the ninth inlet E₉.

The refrigerating fluid/heat transfer liquid heat exchanger advantageously comprises an inlet orifice for refrigerating fluid FR that is in fluid connection with the second outlet S₂.

The internal heat exchanger advantageously comprises a high-pressure outlet that is in fluid connection with the first inlet E₁ and the third inlet E₃.

The internal heat exchanger advantageously comprises a high-pressure inlet that is in fluid connection with the third outlet S₃.

The internal heat exchanger advantageously comprises a low-pressure outlet that is in fluid connection with an inlet for refrigerating fluid FR to the inside of the compressor.

The internal heat exchanger advantageously comprises a low-pressure inlet that is in fluid connection with an outlet for refrigerating fluid FR out of the accumulator.

The accumulator advantageously comprises an orifice for the arrival of refrigerating fluid FR that is in fluid connection with the outlet S₄.

The refrigerating fluid/heat transfer fluid heat exchanger advantageously comprises an opening for receiving the refrigerating fluid FR that is in fluid connection with the compressor.

The refrigerating fluid/heat transfer fluid heat exchanger advantageously comprises an opening for discharging the refrigerating fluid FR to the second inlet E₂, the fourth inlet E₄ and the fifth inlet E₅.

The air conditioning loop preferentially comprises at least any one of five three-way valves, including:
a first three-way valve that is interposed between the refrigerating fluid/heat transfer fluid heat exchanger, the fifth inlet E₅, the fourth inlet E₄ and the second inlet E₂,
a second three-way valve that is interposed between the first three-way valve, the fourth inlet E₄ and the second inlet E₂,
a third three-way valve that is interposed between an orifice for discharging refrigerating fluid FR out of the refrigerating fluid/ambient air heat exchanger, the seventh inlet E₇ and the eighth inlet E₉,
a fourth three-way valve that is interposed between an outlet orifice for refrigerating fluid FR out of the refrigerating fluid/heat transfer liquid heat exchanger, the sixth inlet E₆ and the ninth inlet E₉,
a fifth three-way valve that is interposed between a high-pressure outlet for a refrigerating fluid FR out of the internal heat exchanger, the first inlet E₁ and the third inlet E₃.

### DESCRIPTION OF THE FIGURES

The present invention will be better understood from a reading of the description that will be made of example embodiments, in relation to the figures in the accompanying drawings, in which:

FIG. 1 is a schematic view of an air conditioning system according to a first variant of the present invention.

FIGS. 2 to 4 are schematic views of the air conditioning system illustrated in the previous figure according to respective operating modes.

FIG. 5 is a schematic view of an air conditioning system according to a second variant of the present invention.

FIGS. 6 to 8 are schematic views of the air conditioning system illustrated in the previous figure according to respective operating modes.

FIG. 9 is a schematic view of an air conditioning system according to a third variant of the present invention.

FIGS. 10 to 12 are schematic views of the air conditioning system illustrated in the previous figure according to respective operating modes.

In the figures, a motor vehicle is equipped with an air conditioning system 1 for modifying the aerothermal parameters of the air contained inside the cabin. Such a modification is obtained from the delivery of an internal air flow 2 inside the cabin.

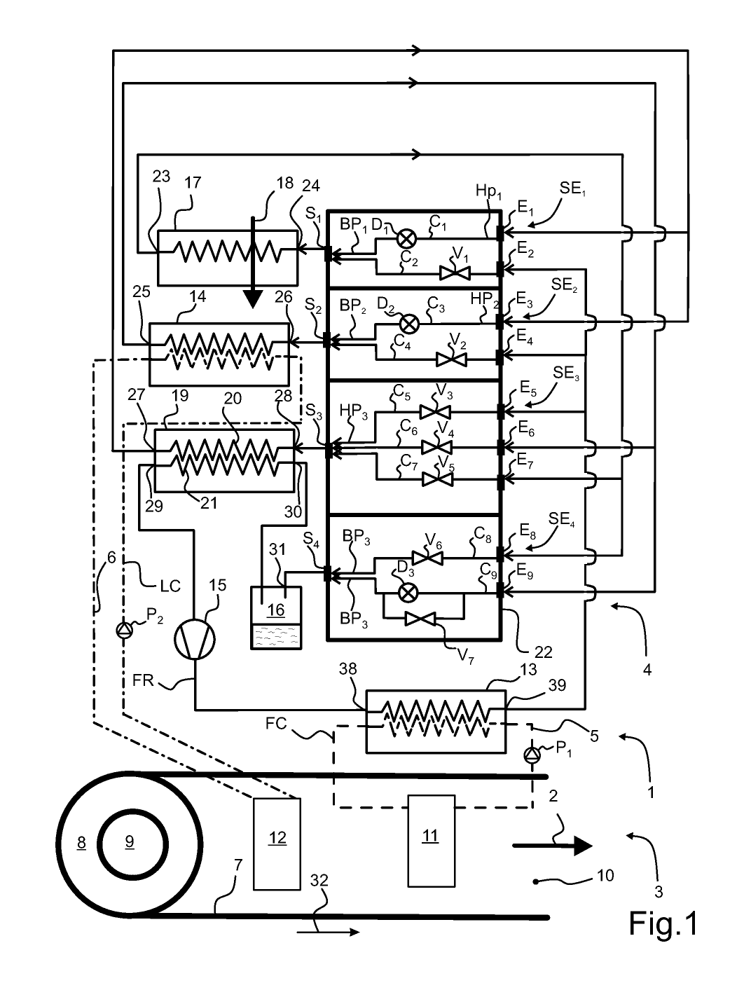

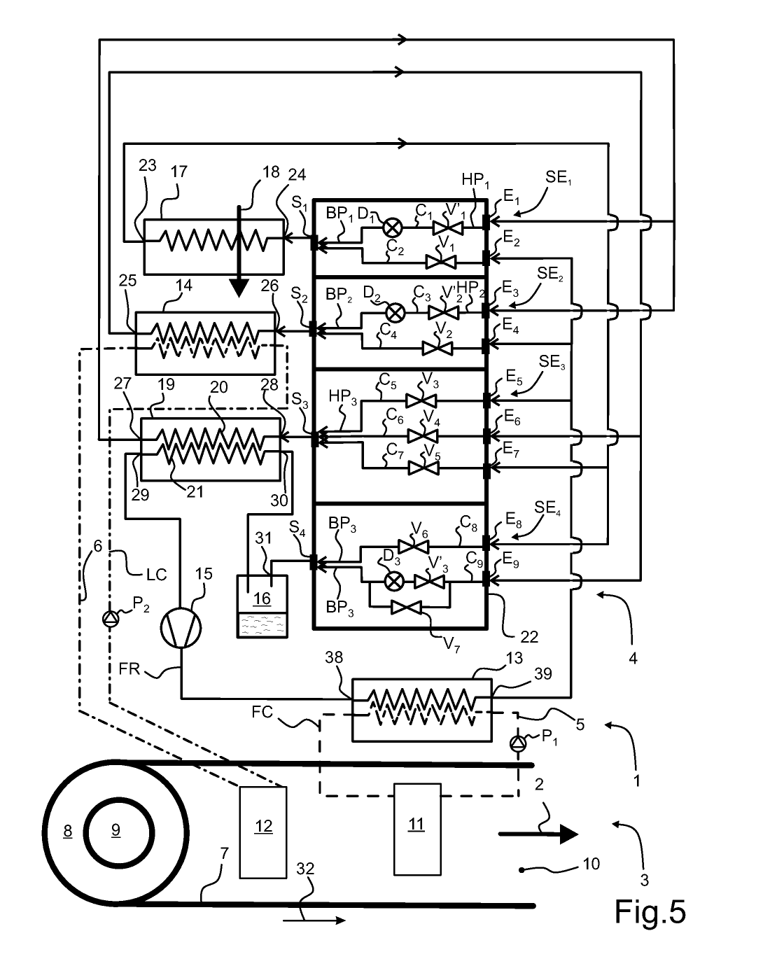

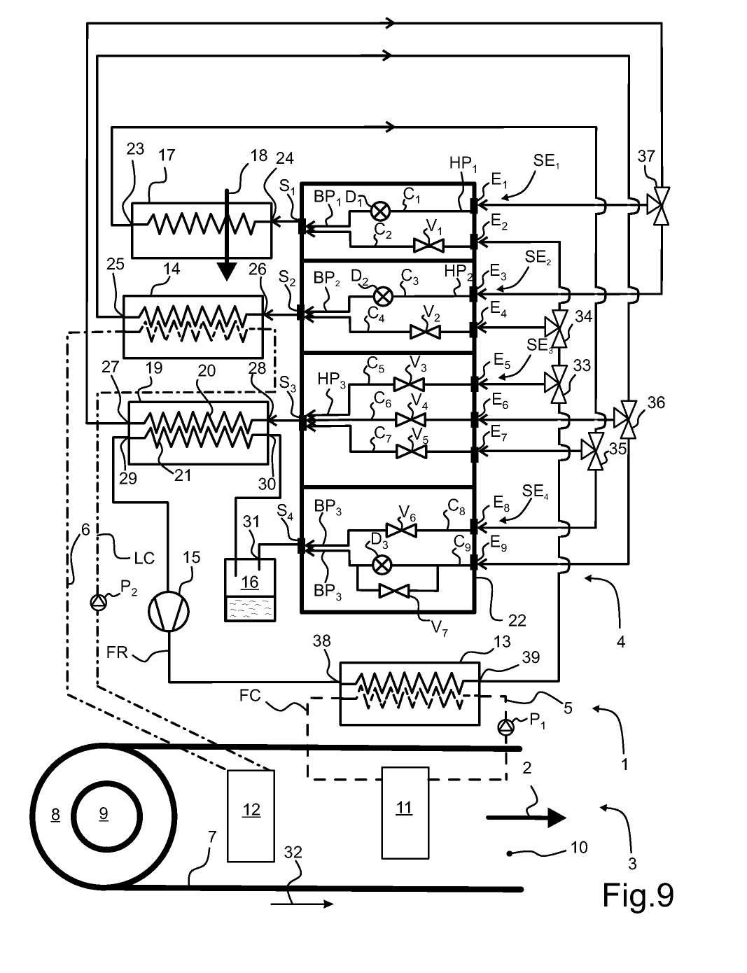

For this purpose, the air conditioning system 1 comprises:
a ventilation, heating and/or air conditioning installation 3 able to channel the circulation of the internal air flow 2 prior to its delivery inside the cabin,
an air conditioning loop 4 inside which a refrigerating fluid FR circulates, preferentially supercritical, such as carbon dioxide, known by the name R744, or such as an azeotropic compound known by the name HFO-1234 yf,
a first secondary loop 5, shown in broken lines in FIG. 1, FIG. 5 and FIG. 9, inside which a heat transfer fluid FC, such as a mixture of water and glycol, circulates, and
a second secondary loop 6, shown in alternating dot and dash lines in FIG. 1, FIG. 5 and FIG. 9, inside which a heat transfer fluid LC flows, such as a mixture of water and glycol.

The ventilation, heating and/or air conditioning installation 3 consists mainly of a housing 7 produced from plastics material and generally housed under the dashboard of the vehicle. Said installation 3 houses an impeller 8 for making the internal air flow 2 circulate from at least one air admission orifice 9 to at least one air discharge orifice 10 that the housing 7 has. The air discharge orifice 10 enables the internal air flow 2 to be delivered out of the housing 7 to the vehicle cabin.

To enable the temperature of the internal air flow 2 to be modified prior to the delivery thereof in the cabin, said installation 3 houses a first heat transfer fluid/internal air flow heat exchanger 11 to allow heat transfer between the heat transfer fluid FC and the internal air flow 2, and a second heat transfer liquid/internal air flow heat exchanger 12 to allow a heat transfer between the heat transfer liquid LC and the internal air flow 2.

The first heat transfer fluid/internal air flow heat exchanger 11 consists of the first secondary loop 5. The latter also comprises a refrigerating fluid/heat transfer fluid heat exchanger 13 to allow a heat transfer between the refrigerating fluid FR and the heat transfer fluid FC. Finally, the first secondary loop 5 comprises a first pump P₁ for causing the heat transfer fluid FC to circulate between the first heat transfer fluid/internal air flow heat exchanger 11 and the refrigerating fluid/heat transfer fluid heat exchanger 13.

The second heat transfer liquid/internal air flow heat exchanger 12 consists of the second secondary loop 6. The latter also comprises a refrigerating fluid/heat transfer liquid heat exchanger 14 to allow a heat exchange between the refrigerating fluid FR and the heat transfer liquid LC. Finally, the second secondary loop 6 comprises a second pump P₂ for causing the heat transfer fluid LC to circulate between the second heat transfer liquid/internal air flow heat exchanger 12 and the refrigerating fluid/heat transfer liquid heat exchanger 14.

The refrigerating fluid/heat transfer fluid heat exchanger 13 and the refrigerating fluid/heat transfer liquid heat exchanger 14 also constitute the air conditioning loop 4 to allow a heat transfer between the refrigerating fluid FR and respectively the heat transfer fluid FC and the heat transfer liquid LC.

The air conditioning loop 4 also comprises a compressor 15 for raising the refrigerating fluid FR to high pressure. The compressor 15 is preferentially associated with an accumulator 16 to prevent an admission of refrigerating fluid FR in the liquid state inside the compressor 15. The air conditioning loop 4 also comprises a refrigerating fluid/ambient air heat exchanger 17 to allow a heat transfer between the refrigerating fluid FR and an ambient air flow 18 that passes through it. The latter is in particular a flow of air external to the vehicle. The refrigerating fluid/ambient air heat exchanger 17 is preferentially placed at the front of the vehicle to facilitate heat transfer between the refrigerating fluid FR and the ambient air flow 18. The air conditioning loop 4 also comprises a plurality of pressure reduction members D₁, D₂, D₃ to allow a reduction in pressure of the refrigerating fluid FR from high pressure to low pressure. The pressure reduction members D₁, D₂, D₃ are in particular electronically controlled pressure reduction devices. Thus the air conditioning loop 4 comprises a plurality of high-pressure lines HP', HP₂, HP₃ provided between the compressor 15 and at least one of the pressure reduction members D₁, D₂, D₃ as well as a plurality of low-pressure lines BP₁, BP₂, BP₃, provided between at least one of the pressure reduction members D₁, D₂, D₃ and the compressor. Finally, the air conditioning loop 4 comprises an internal heat exchanger 19 that comprises a high-pressure channel 20 and a low-pressure channel 21 to allow heat transfer between the refrigerating fluid FR circulating inside the high-pressure channel 20 and the refrigerating fluid FR circulating within the low-pressure channel 21. According to various operating modes of the air conditioning loop 4, the high-pressure channel 20 constitutes one of the high-pressure lines HP₁, HP₂, HP₃ while the low-pressure channel 21 constitutes one of the low-pressure lines BP₁, BP₂, BP₃.

The air conditioning loop 4 is able to function in heating mode in which the internal air flow 2 is heated by the first heat transfer fluid/internal air flow heat exchanger 11 and the second heat transfer liquid/internal air flow heat exchanger 12. The air conditioning loop 4 is also able to function in air conditioning mode in which the internal air flow 2 is cooled by the second heat transfer liquid/internal air flow heat exchanger 12, the first heat transfer fluid/internal air flow heat exchanger 11 being inoperative. Finally, the air conditioning loop is able to function in dehumidification mode in which the internal air flow 2 is first of all cooled by the second heat transfer liquid/air flow heat exchanger 12 and then heated by the first heat transfer fluid/internal air flow heat exchanger 11.

To allow simple and effective management of the circulation of the refrigerating fluid FR within the air conditioning loop 4, whatever the operating mode of the latter, while minimising the risks of leakage of refrigerating fluid FR, the present invention proposes to equip the air conditioning loop 4 with a distribution unit 22 comprising nine inlets E₁, E₂, E₃, E₄, E₅, E₆, E₇, E₈, E₉ for admitting refrigerating fluid FR to said unit and four outlets S₁, S₂, S₃, S₄ for discharging refrigerating fluid FR out of said unit 22. The latter is a unitary element that can be handled in a single piece. Nevertheless, the distribution unit 22 consists of four distinct subassemblies SE₁, SE₂, SE₃, SE₄ connected to one another by bolting, interlocking or any other similar fixing means. Two of these subassemblies SE₁, SE₂, SE₃, SE₄, namely the first subassembly SE₁ and the second subassembly SE₂, are similar, which reduces the manufacturing and maintenance costs.

The first sub-assembly SE₁ comprises a first inlet E₁ and a second inlet E₂ for refrigerating fluid FR within said unit 22 and a first outlet S₁ for refrigerating fluid FR out of said unit 22. The first outlet S₁ is in fluid communication with the first inlet E₁ and the second inlet E₂. More particularly, a first channel C₁ is provided between the first inlet E₁ and the first outlet S₁ to allow a flow of refrigerating fluid FR from the first inlet E₁ to the second outlet S₁. More particularly again, a second channel C₂ is provided between the second inlet E₂ and the first outlet S₁ to allow a flow of refrigerating fluid FR from the first inlet E₂ to the first outlet S₁. The first channel C₁ is provided with a first pressure reduction member D₁ while the second channel C₂ is equipped with a first shutter V₁ able to allow or prevent passage of the refrigerating fluid FR within the second channel C₂.

The second sub-assembly SE₂ comprises a third inlet E₃ and a fourth inlet E₄ for refrigerating fluid FR within said unit 22 and a second outlet S₂ for refrigerating fluid FR out of the unit 22. The second outlet S₂ is in fluid communication with the third inlet E₃ and the fourth inlet E₄. More particularly, a third channel C₃ is provided between the third inlet E₃ and the second outlet S₂ to allow a flow of refrigerating fluid FR from the third inlet E₃ to the second outlet S₂. More particularly again, a fourth channel C₄ is provided between the fourth inlet E₄ and the second outlet S₂ to allow a flow of refrigerating fluid FR from the fourth inlet E₄ to the second outlet S₂. The third channel C₃ is provided with the second pressure reduction member D₂ while the fourth channel C₄ is equipped with a second shutter V₂ able to allow or prevent passage of refrigerating fluid FR within the fourth channel C₄.

The third sub-assembly SE₃ comprises a fifth inlet E₅, a sixth inlet E₆ and a seventh inlet E₇ for refrigerating fluid FR within said unit 22 and a third outlet S₃ for refrigerating fluid FR out of said unit 22. The third outlet S₃ is in fluid communication with the fifth inlet E₅, the sixth inlet E₆ and the seventh inlet E₇. More particularly, a fifth channel C₅ is provided between the fifth inlet E₅ and the third outlet S₃ to allow a flow of refrigerating fluid FR from the fifth inlet E₅ to the third outlet S₃. More particularly, a sixth channel C₆ is provided between the sixth inlet E₆ and the third outlet S₃ to allow a flow of refrigerating fluid FR from the sixth inlet E₆ to the third outlet S₃. More particularly finally, a seventh channel C₇ is provided between the seventh inlet E₇ and the third outlet S₃ to allow a flow of refrigerating fluid FR from the seventh inlet E₇ to the third outlet S₃. The fifth channel C₅ is provided with a third shutter V₃ able to allow or prevent passage of refrigerating fluid FR within the fifth channel C₅. The sixth channel C₆ is provided with a fourth shutter V₄ able to allow or prevent passage of the refrigerating fluid FR within the sixth channel C₆. The seventh channel C₇ is provided with a fifth shutter V₅ able to allow or prevent a passage of refrigerating fluid FR within the seventh channel C₇.

The fourth sub-assembly SE₄ comprises an eighth inlet E₈ and a ninth inlet E₉ for refrigerating fluid FR within said unit 22 and a fourth outlet S₄ for refrigerating fluid FR out of said unit 22. The fourth outlet S₄ is in fluid communication with the eighth inlet E₈ and the ninth inlet E₉. More particularly, an eighth channel C₈ is provided between the eighth inlet E₈ and the fourth outlet S₄ to allow a flow of refrigerating fluid FR from the eighth inlet E₈ to the fourth outlet S₄. More particularly again, a ninth channel C₉ is provided between the ninth inlet E₉ and the fourth outlet S₄ to allow a flow of refrigerating fluid FR from the ninth inlet E₉ to the fourth outlet S₄. The eighth channel C₈ is provided with a third shutter V₃ able to allow or prevent passage of the refrigerating fluid FR within the eighth channel C₈. The ninth channel C₉ is equipped with the third pressure reduction member D₃. A fourth shutter V₄ is placed in parallel to the third pressure-reduction member D₃ to allow a circulation of the refrigerating fluid FR between the ninth inlet E₉ and the fourth outlet S₄ by means of a bypassing of the third pressure reduction member D₃.

The refrigerating fluid/ambient air heat exchanger 17 comprises an orifice 23 for discharging refrigerating fluid FR that is in fluid connection with the seventh inlet E₇ and the eighth inlet E₈. The refrigerating fluid/ambient air heat exchanger 17 also comprises an inlet orifice 24 for refrigerating fluid FR that is in fluid connection with the first outlet S₁.

The refrigerating fluid/heat transfer liquid heat exchanger 14 comprises an outlet orifice 25 for refrigerating fluid FR that is in fluid connection with the sixth inlet E₆ and the ninth inlet E₉. The refrigerating fluid/heat transfer liquid heat exchanger 14 also comprises an inlet orifice 26 for refrigerating fluid FR that is in fluid connection with the second outlet S₂.

The internal heat exchanger 19 comprises a high-pressure outlet 27 that is in fluid connection with the first inlet E₁ and the third inlet E₃. The internal heat exchanger 19 also comprises a high-pressure inlet 28 that is in fluid connection with the third outlet S₃. The high-pressure outlet 27 and the high-pressure inlet 28 are connected to each other fluid-wise by means of the high-pressure channel 20. At the same time, the internal heat exchanger 19 comprises a low-pressure output 29 that is in fluid connection with a refrigerating fluid inlet of the compressor 15. The internal heat exchanger 19 also comprises a low-pressure inlet 30 that is in fluid connection with an outlet for the refrigerating fluid FR out of the accumulator 16. The low-pressure outlet 29 and the low-pressure inlet 30 are connected to each other fluid-wise by means of the low-pressure channel 21. The high-pressure channel 20 and the low-pressure channel 21 are arranged with respect to each other so as to allow heat transfer between the refrigerating fluid FR circulating inside one of the channels 20, 21 and the refrigerating fluid FR circulating inside the other one of the channels 21, 20.

The accumulator 16 also comprises an inlet orifice 31 for the refrigerating fluid FR coming from the outlet S₄.

The refrigerating fluid/heat transfer fluid heat exchanger 13 receives the refrigerating fluid FR coming from the compressor 15 in order to discharge it to the second inlet E₂ or the fourth inlet E₄ or the fifth inlet E₅ with which the refrigerating fluid/heat transfer fluid heat exchanger 13 is in fluid connection.

In FIGS. 1 to 4, the first pressure reduction member D₁, the second pressure reduction member D₂ and the third pressure reduction member D₃ are able to allow or prevent passage of the refrigerating fluid FR within the channel C₁, C₂, C₃ to which they are respectively allocated.

In FIGS. 5 to 12, the first pressure reduction member D₁, the second pressure reduction member D₂ and the third pressure reduction member D₃ are not able to prevent passage of the refrigerating fluid FR within the channel C₁, C₂, C₃ to which they are respectively allocated.

In FIGS. 5 to 8, a first valve V′₁ is interposed on the first channel C₁ between the first pressure reduction member D₁ and the first inlet E₁. The first valve V′₁ is able to allow or prevent passage of the refrigerating fluid FR within the first channel C₁. Likewise, a second valve V′₂ is interposed on the third channel C₃ between the second pressure reduction member D₂ and the third inlet E₃. The second valve V′₂ is able to allow or prevent passage of the refrigerating fluid FR within the third channel C₃. Finally, a third valve V′₃ is interposed on the ninth channel C₉ between the third pressure reduction member D₃ and the ninth inlet E₉. The third valve V′₃ is able to allow or prevent passage of the refrigerating fluid FR within the ninth channel C₉.

In FIGS. 9 to 12, a first three-way valve 33 is interposed between the refrigerating fluid/heat transfer fluid heat exchanger 13, the fifth inlet E₅, the fourth inlet E₄ and the second inlet E₂, to enable the refrigerating fluid FR coming from the refrigerating fluid/heat transfer fluid heat exchanger 13 to flow towards the fifth inlet E₅ or towards the fourth inlet E₄ and the second inlet E₂. A second three-way valve 34 is interposed between the first three-way valve 33, the fourth inlet E₄ and the second inlet E₂, to enable the refrigerating fluid FR coming from the first three-way valve 33 to flow towards the fourth inlet E₄ or the second inlet E₂. A third three-way valve 35 is interposed between the orifice 23 discharging refrigerating fluid FR out of the refrigerating fluid/ambient air heat exchanger 17 and the seventh inlet E₇ and the eighth inlet E₈, to enable the refrigerating fluid FR coming from the refrigerating fluid/ambient air heat exchanger 17 to flow towards the seventh inlet E₇ or the eighth inlet E₈. A fourth three-way valve 36 is interposed between the outlet orifice 25 for refrigerating fluid FR to leave the refrigerating fluid/heat transfer liquid heat exchanger and the sixth inlet E₆ and the ninth inlet E₉, to enable the refrigerating fluid FR coming from the refrigerating fluid/heat transfer liquid heat exchanger 14 to flow towards the sixth inlet E₆ or the ninth inlet E₉. Finally, a fifth three-way valve 37 is interposed between the high-pressure outlet 27 for refrigerating fluid FR to leave the internal heat exchanger 19 and the first inlet E₁ and the third inlet E₃, to enable the refrigerating fluid FR coming from the internal heat exchanger 19 to flow towards the first inlet E₁ and the third inlet E₃.

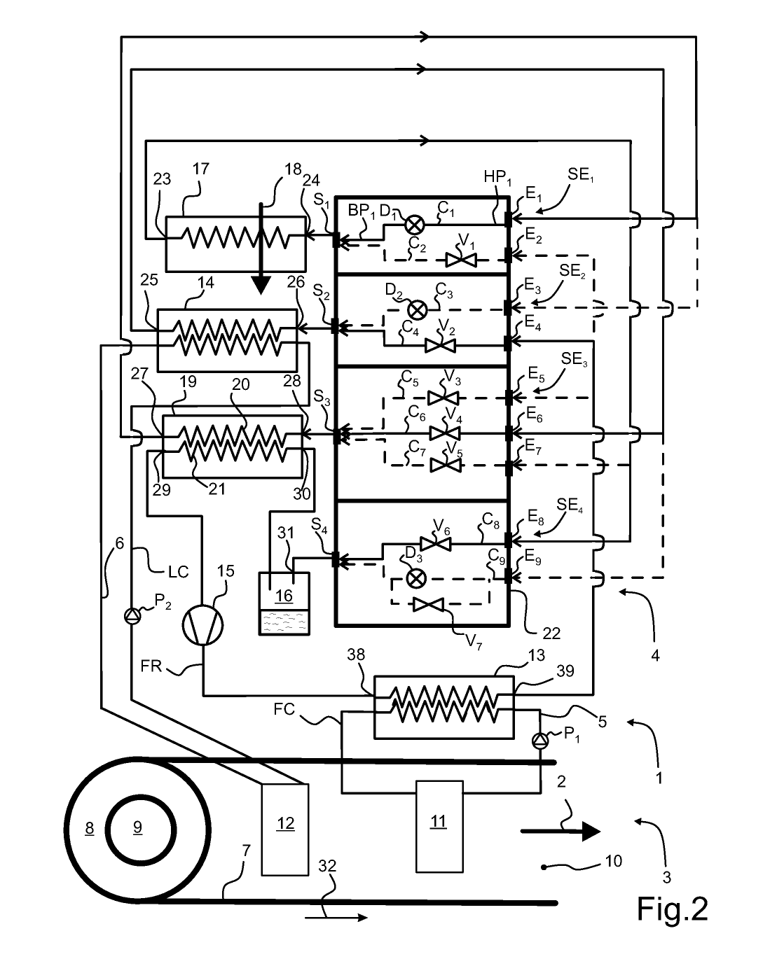

In FIGS. 2 to 4, FIGS. 6 to 8 and FIGS. 10 to 12 the air conditioning system 1 is illustrated according to various operating modes. The pipes inside which the refrigerating fluid FR flows are shown in solid lines and the pipes inside which the refrigerating fluid FR does not flow are shown in dotted lines.

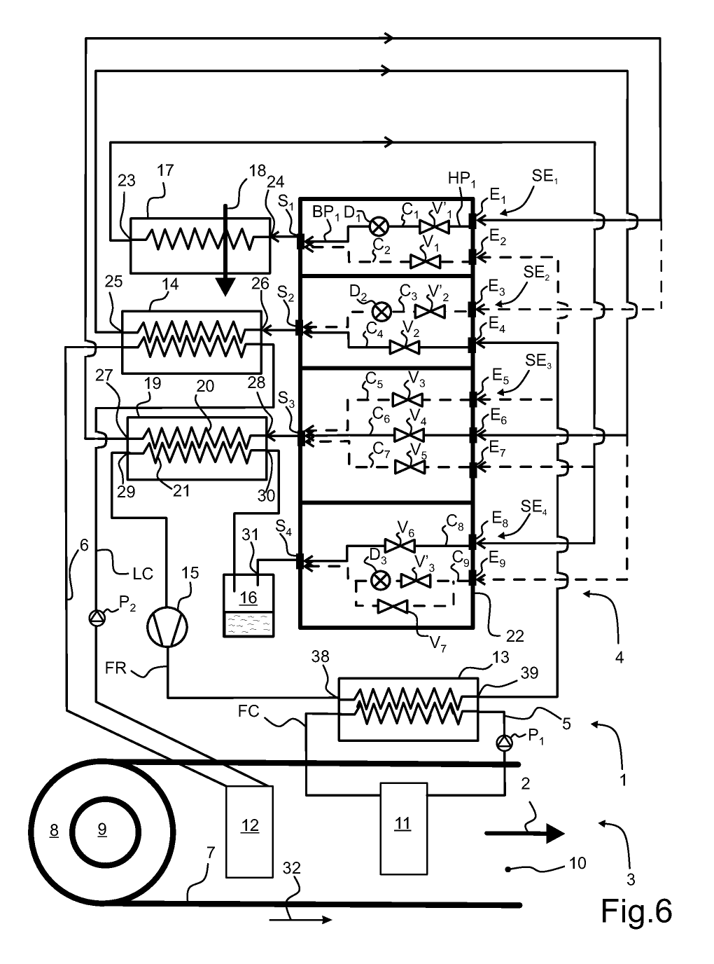

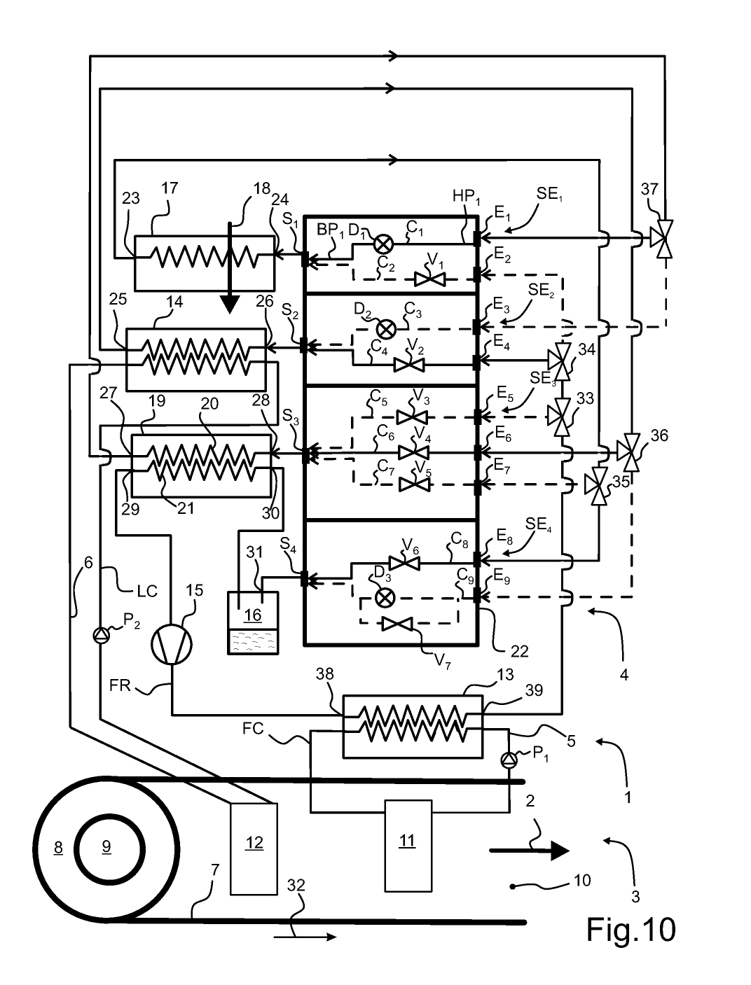

In FIGS. 2, 6 and 10, the air conditioning system 1 functions in the mode in which the internal air flow 2 is heated. According to this mode, the first shutter V₁ is closed, the second shutter V₂ is open, the third shutter V₃ is closed, the fourth shutter V₄ is open, the fifth shutter V₅ is closed, the sixth shutter V₆ is open and the seventh shutter V₇ is closed. In addition, the two pumps P₁ and P₂ are switched on. In FIG. 2, the first pressure reduction member D₁ is open, the second pressure reduction member D₂ is closed and the third pressure reduction member D₃ is closed. In FIG. 6, the first valve V′₁ is open, the second valve V′₂ is closed and the third valve V′₃ is closed. In FIG. 10, the first three-way valve 33 allows passage of the refrigerating fluid FR to the second three-way valve 34 and prevents such passage to the fifth inlet E₅. The second three-way valve 34 allows passage of the refrigerating fluid FR to the fourth inlet E₄ and prevents such passage to the second inlet E₂. The third three-way valve 35 allows passage of the refrigerating fluid FR to the eighth inlet E₈ and prevents such passage to the seventh inlet E₇. The fourth three-way valve 36 allows passage of the refrigerating fluid FR to the sixth inlet E₆ and prevents such passage to the ninth inlet E₉. The fifth three-way valve 37 allows passage of the refrigerating fluid FR to the first inlet E₁ and prevents such passage to the third inlet E₃.

Thus, in heating mode, the compressor 15 receives the refrigerating fluid FR in the gaseous state in order to compress it at high pressure, in particular supercritical, and directs it to the refrigerating fluid/heat transfer fluid heat exchanger 13. The latter is arranged to allow transfer of heat at relatively constant pressure from the refrigerating fluid FR to the heat transfer fluid FC, which transmits this heat to the internal air flow 2 by means of said first heat exchanger 11. Then the refrigerating fluid FR enters inside the distribution unit 22 by means of the fourth inlet E₄, in order to flow inside the fourth channel C₄ and the second shutter V₂ as far as the second outlet S₂. Then the refrigerating fluid FR flows through the refrigerating fluid/heat transfer liquid heat exchanger 14, yielding up heat to the heat transfer liquid LC, which transmits this heat to the internal air flow 2 by means of said second heat exchanger 12. The temperature of the heat transfer liquid LC is lower than the temperature of the heat transfer fluid FC. Thus the second heat exchanger 12 is placed upstream of the first heat exchanger 11 in a direction of flow 32 of the internal air flow 2 inside the housing 7, so that the heat transfer between the heat transfer liquid LC and the internal air flow 2 constitutes a preheating of the latter prior to heating thereof by means of the first heat exchanger 11. The refrigerating fluid FR then enters inside the distribution unit 22 by means of the sixth inlet E₆ in order to flow inside the sixth channel C₆ and the fourth shutter V₄ as far as the third outlet S₃. Then the refrigerating fluid FR flows inside the high-pressure channel 20 of the internal heat exchanger 19 so as to yield up heat to the refrigerating fluid FR flowing inside the low-pressure channel 21. Then the refrigerating fluid FR returns to the distribution unit 22 by means of the first inlet E₁ in order to flow inside the first channel C₁ as far as the first pressure reduction member D₁. The refrigerating fluid FR undergoes a pressure reduction from high pressure to low pressure. The refrigerating fluid FR is discharged out of the distribution unit 22 by means of the first outlet S₁ until it enters inside the refrigerating fluid/ambient air heat exchanger 17 inside which the refrigerating fluid receives heat yielded up by the ambient air flow 18. The refrigerating fluid FR next rejoins the distribution unit 22 by means of the eighth inlet E₈ in order to flow inside the eighth channel C₈ and the sixth shutter V₆ as far as the fourth outlet S₄. The refrigerating fluid FR then enters inside the accumulator 16 inside which the refrigerating fluid FR in the liquid state is stored while the refrigerating fluid FR in the gaseous state is discharged to the low-pressure channel 21 of the internal heat exchanger 19, before returning to the compressor 15.

These arrangements are such that, in heating mode, the first low-pressure line BP₁ comprises in this order the first outlet S₁, the refrigerating fluid/ambient air heat exchanger 17, the eighth inlet E₈, the eighth channel C₈ provided with the sixth shutter V₆, the fourth outlet S₄, the accumulator 16 and a low-pressure channel 21 of the internal heat exchanger 19 in order to end up at the compressor 15. The first high-pressure line HP₁ comprises in this order the first refrigerating fluid/heat transfer fluid heat exchanger 13, the fourth inlet E₄, the fourth channel C₄ provided with the second shutter V₂, the second outlet S₂, the refrigerating fluid/heat transfer liquid heat exchanger 14, the sixth inlet E₆, the sixth channel C₆ provided with the fourth shutter V₄, the third outlet S₃, the high-pressure channel 20 of the internal heat exchanger 19, the first inlet E₁ and the first channel C₁ as far as the pressure reduction member D₁.

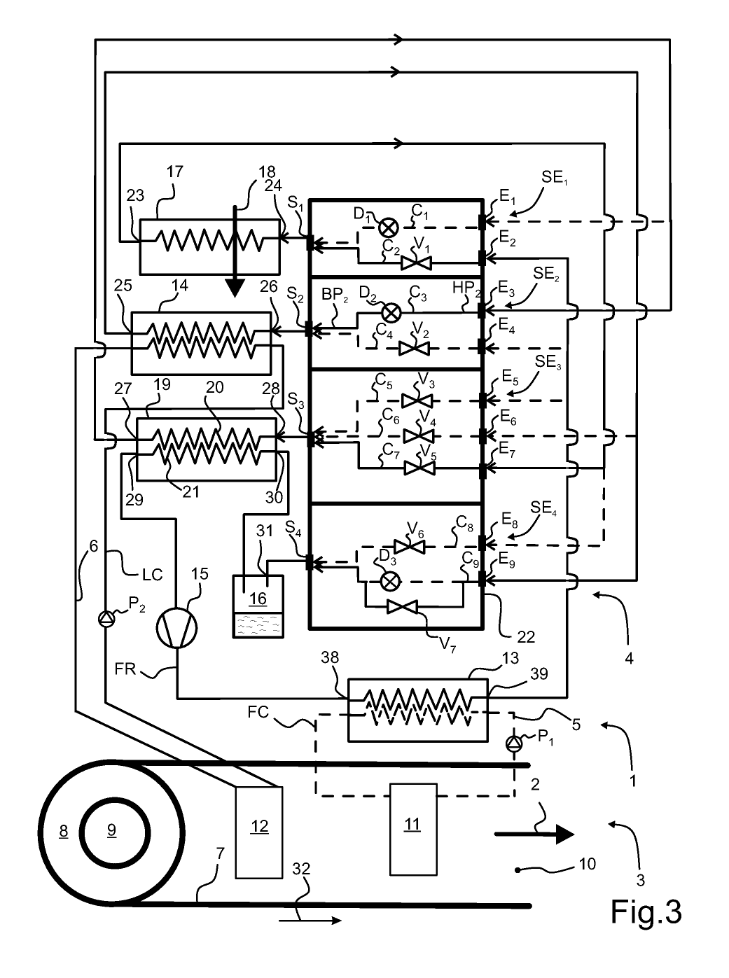

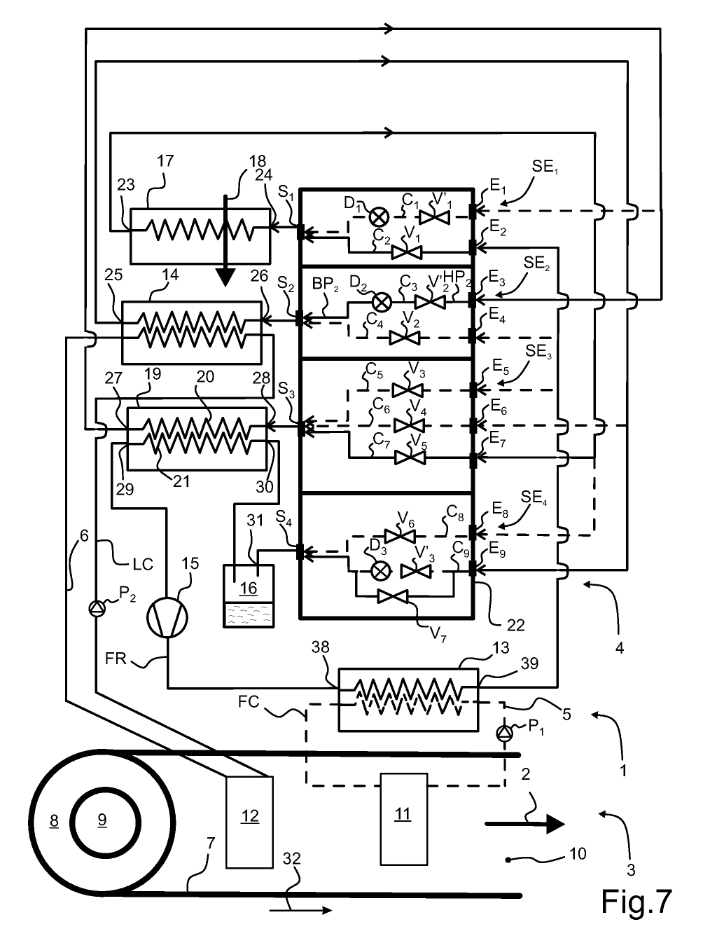

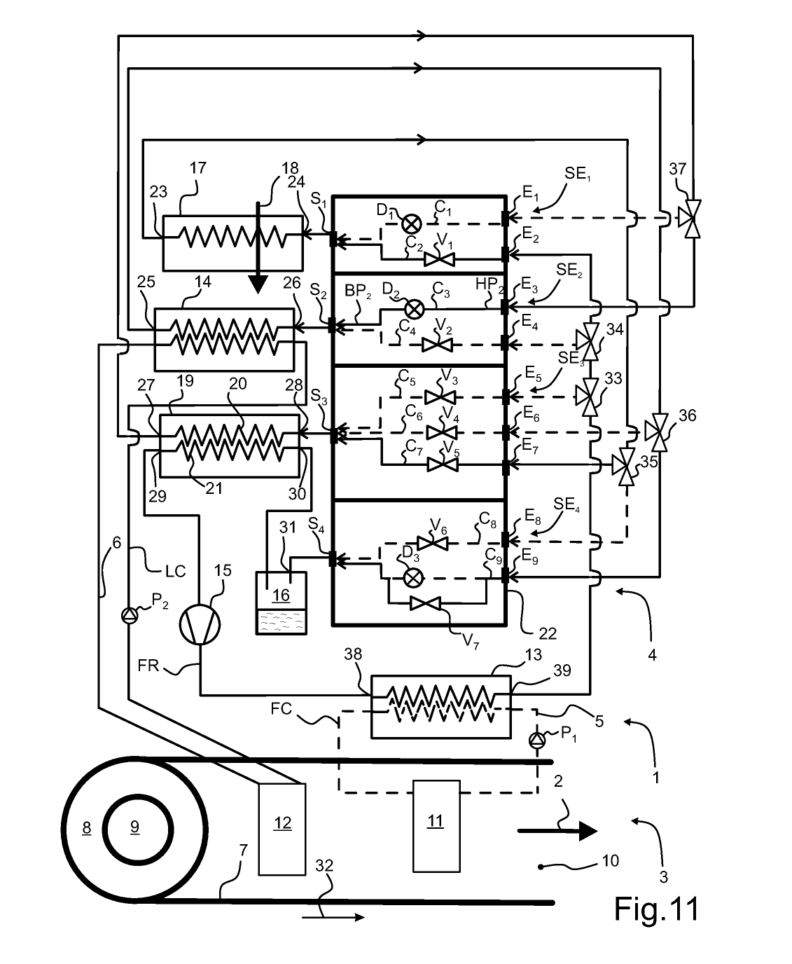

In FIGS. 3, 7 and 11, the air conditioning system 1 functions in air conditioning mode, that is to say in a mode designed to cool the internal air flow 2. According to this mode, the first shutter V₁ is open, the second shutter V₂ is closed, the third shutter V₃ is closed, the fourth shutter V₄ is closed, the fifth shutter V₅ is open, the sixth shutter V₆ is closed and the seventh shutter V₇ is open. In addition, the first pump P₁ is not switched on while the second pump P₂ is switched on. In FIG. 3, the first pressure reduction member D₁ is closed, the second pressure reduction member D₂ is open, the third pressure reduction member D₃ is closed. In FIG. 7, the first valve V′₁ is closed, the second valve V′₂ is open and the third valve V′₃ is closed. In FIG. 11, the first three-way valve 33 allows passage of the refrigerating fluid FR to the second three-way valve 34 and prevents such passage to the fifth inlet E₅. The second three-way valve 34 allows passage of the refrigerating fluid FR to the second inlet E₂ and prevents such passage to a fourth inlet E₄. The third three-way valve 35 allows passage of the refrigerating fluid FR to the seventh inlet E₇ and prevents such passage to the eighth inlet E₈. The fourth three-way valve 36 allows passage of the refrigerating fluid FR to the ninth inlet E₉ and prevents such passage to the sixth inlet E₆. The fifth three-way valve 37 allows passage of the refrigerating fluid FR to the third inlet E₃ and prevents such passage to the first inlet E₁.

Thus, in air conditioning mode, the compressor 15 receives the refrigerating fluid FR in the gaseous state in order to compress it at high pressure, in particular supercritical, and direct it to the refrigerating fluid/heat transfer fluid heat exchanger 13. The pump P₁ being stopped, the heat transfer inside the refrigerating fluid/heat transfer fluid heat exchanger 13 enters the refrigerating fluid FR and the heat transfer fluid FC is minimised, or even zero. Then the refrigerating fluid FR enters inside the distribution unit 22 by means of the second inlet E₂ in order to flow inside the second channel C₂ and the first shutter V₁ as far as the first outlet S₁. Then the refrigerating fluid FR flows inside the refrigerating fluid/ambient air heat exchanger 17 inside which the refrigerating fluid FR yields up heat to the ambient air flow 18 at a relatively constant pressure. The refrigerating fluid FR then enters inside the distribution unit 22 by means of the seventh inlet E₇ in order to flow inside the seventh channel C₇ and the fifth shutter V₅ as far as the third outlet S₃. Then the refrigerating fluid FR flows inside the high-pressure channel 20 of the internal heat exchanger 19 so as to yield up heat to the refrigerating fluid FR flowing inside the low-pressure channel 21. The refrigerating fluid FR next enters inside the distribution unit 22 by means of the third inlet E₃ in order to flow inside the third channel C₃ and the second pressure reduction member D₂. The refrigerating fluid FR undergoes pressure reduction from high pressure to low pressure. Then the refrigerating fluid FR flows inside the refrigerating fluid/heat transfer liquid heat exchanger 14, capturing heat from the heat transfer liquid LC, which cools. The heat transfer liquid LC is then able to cool the internal air flow 2 by means of said second heat exchanger 12. The refrigerating fluid FR then enters inside the distribution unit 22 by means of the ninth inlet E₉ in order to flow inside the ninth channel C₉ and the seventh shutter V₇ as far as the fourth outlet S₄. The refrigerating fluid FR then enters inside the accumulator 16 inside which the refrigerating fluid FR in the liquid state is stored while the refrigerating fluid FR in the gaseous state is discharged to the low-pressure channel 21 of the internal heat exchanger 19, before returning to the compressor 15.

These arrangements are such that, in air conditioning mode, the second low-pressure line BP₂ comprises in this order the second outlet S₂, the second refrigerating fluid/heat transfer liquid heat exchanger 14, the ninth inlet E₉, the seventh shutter V₇, the fourth outlet S₄, the accumulator 16 and the low-pressure channel 21 of the internal heat exchanger 19 in order to end up at the compressor 15. The second high-pressure line HP₂ comprises the first refrigerating fluid/heat transfer fluid heat exchanger 13, the second inlet E₂, the first shutter V₁, the first outlet S₁, the refrigerating fluid/ambient air heat exchanger 17, the seventh inlet E₇, the seventh channel C₇ provided with the fifth shutter V₅, the high-pressure channel 20 of the internal heat exchanger 19, the third inlet E₃ and the third channel C₃ as far as the second pressure reduction member D₂.

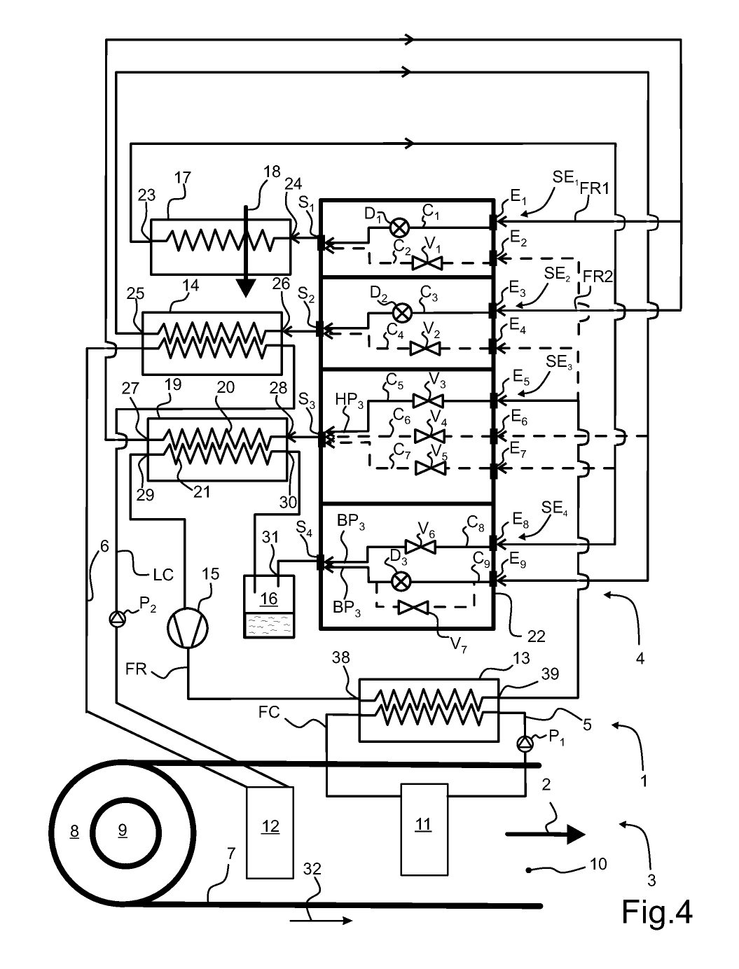

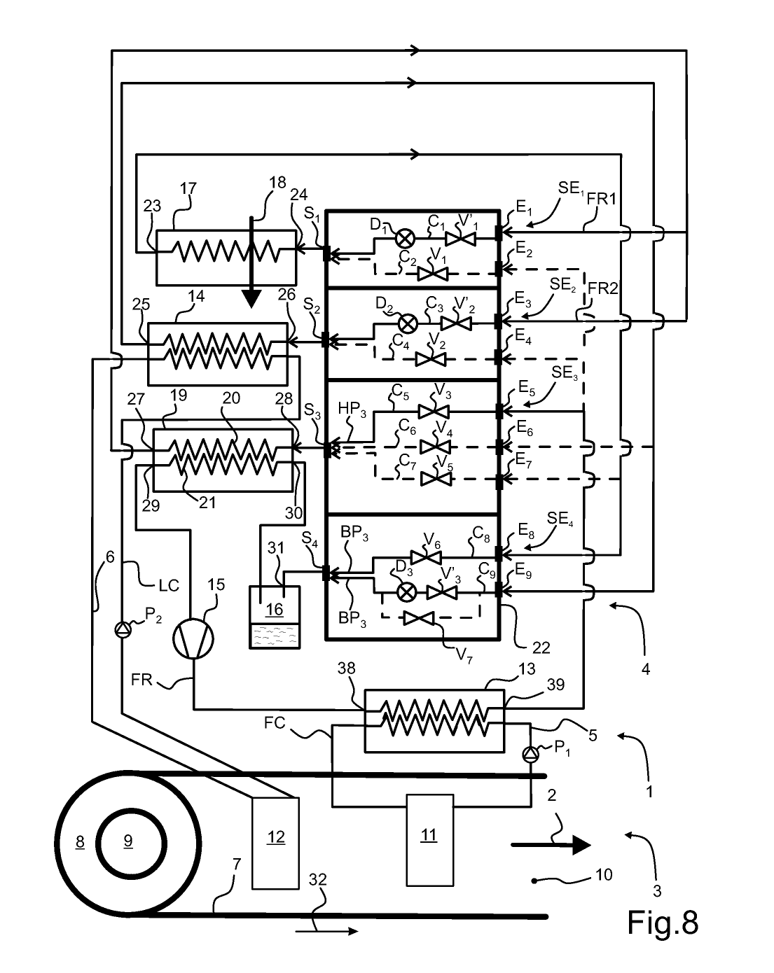

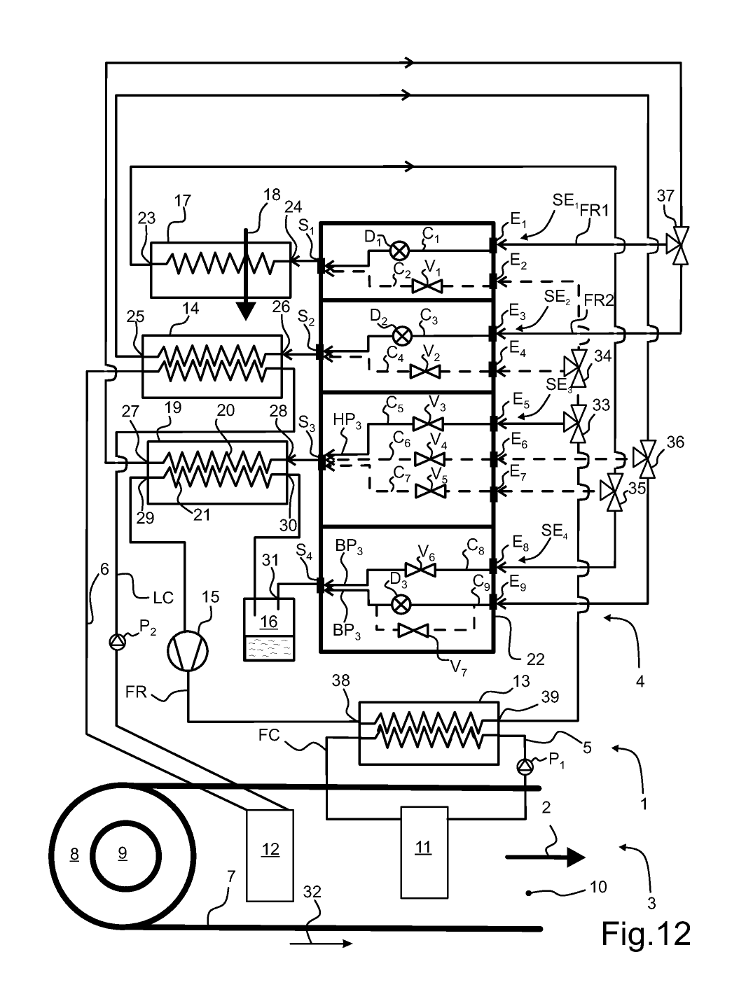

In FIGS. 4, 8 and 12, the air conditioning system 1 functions in dehumidification mode, that is to say in a mode designed first of all to cool the internal air flow 2, and then to re-heat the latter. According to this mode, the first shutter V₁ is closed, the second shutter V₂ is closed, the third shutter V₃ is open, the fourth shutter V₄ is closed, the fifth shutter V₅ is closed, the sixth shutter V₆ is open, and the seventh shutter V₇ is closed. In addition, the first pump P₁ and the second pump P₂ are switched on. In FIG. 4, the first pressure reduction member D₁ is open, the second pressure reduction member D₂ is open, the third pressure reduction member D₃ is open. In FIG. 8, the first valve V′₁ is open, the second valve V′₂ is open and the third valve V′₃ is open. In FIG. 12, the first three-way valve 33 allows passage of the refrigerating fluid FR to the fifth inlet E₅ and prevents such passage to the second three-way valve 34. The third three-way valve 35 allows passage of the refrigerating fluid FR to the eighth inlet E₈ and prevents such passage to the seventh inlet E₇. The fourth three-way valve 36 allows passage of the refrigerating fluid FR to the ninth inlet E₉ and prevents such passage to the sixth inlet E₆. The fifth three-way valve 37 allows passage of the refrigerating fluid FR to the third inlet E₃ and to the first inlet E₁.

Thus, in dehumidification mode, the compressor 15 receives the refrigerating fluid FR in the gaseous state in order to compress it at high pressure, in particular supercritical, and direct it to the refrigerating fluid/heat transfer fluid heat exchanger 13. The latter is arranged to allow transfer of heat at relatively constant pressure from the refrigerating fluid FR to the heat transfer fluid FC, which transmits this heat to the internal air flow 2 by means of said first heat exchanger 11. Then the refrigerating fluid FR enters inside the distribution unit 22 by means of the fifth inlet E₅ in order to flow inside the fifth channel C₅ and the third shutter V₃ as far as the third outlet S₃. Then the refrigerating fluid FR flows inside the high-pressure channel 20 of the internal heat exchanger 19 so as to yield up heat to the refrigerating fluid FR flowing inside the low-pressure channel 21. The refrigeration fluid FR is then divided into two portions FR1 and FR2.

A first portion FR1 returns to the distribution unit 22 by means of the first inlet E₁ in order to flow inside the first channel C₁ as far as the first pressure reduction member D₁. The first portion FR1 then undergoes pressure reduction from high pressure to low pressure. Then the first portion FR1 is discharged out of the distribution unit 22 by means of the first outlet S₁ in order to rejoin the refrigeration fluid/ambient air heat exchanger 17 inside which the first portion FR1 picks up heat from the ambient air flow 18. Then the first portion FR1 returns to the distribution unit 22 by means of the eighth inlet E₈. The first portion FR1 then flows inside the eighth channel C₈ and the sixth shutter V₆ in order to reach the fourth outlet S₄.

A second portion FR2 returns to the distribution unit 22 by means of the third inlet E₃ in order to flow inside the third channel C₃ as far as the second pressure reduction member D₂. The second portion FR2 then undergoes pressure reduction from high pressure to an intermediate pressure. Then the second portion FR2 is discharged out of the distribution unit 22 by means of the second outlet S₂ in order to rejoin the refrigeration fluid/heat transfer liquid heat exchanger 14 inside which the second portion FR2 captures heat from the heat transfer liquid LC, which cools. The heat transfer liquid LC is then able to cool the internal air flow 2 by means of said second heat exchanger 12. The latter is placed upstream of said first heat exchanger 11 in the direction of flow 32 of the internal air flow 2 inside the housing 7, the internal air flow 2 is first of all cooled by the second heat exchanger 12 and then reheated by the first heat exchanger 11. These arrangements enable the internal air flow 2 to be dehumidified. The second portion FR2 then returns to the inside of the distribution unit 22 by means of the ninth inlet E₉ in order to flow inside the ninth channel C₉ and the third pressure reduction member D₃. The second portion FR2 then undergoes pressure reduction from intermediate pressure to low pressure. The second portion FR2 then flows as far as the fourth outlet S₄.

At the second outlet S₄, the first portion FR1 and the second portion FR2 join in order then to flow to the accumulator 16. The refrigerating fluid FR then enters inside the accumulator 16 inside which the refrigerating fluid FR in the liquid state is stored while the refrigerating fluid FR in the gaseous state is discharged to the low-pressure channel 21 of the internal heat exchanger 19, before returning to the compressor 15.

These arrangements are such that, in dehumidification mode, the third high-pressure line HP₃ comprises in this order the first refrigeration fluid/heat transfer fluid heat exchanger 13, the fifth inlet E₅, the fifth channel C₅ provided with the third shutter V₃, the third outlet S₃, the high-pressure channel 20 of the internal heat exchanger 19, and then firstly the first inlet E₁ and the first channel C₁ as far as the first pressure reduction member D₁ and secondly the third inlet E₃ and the third channel C₃ as far as the second pressure-reduction member D₂. The third low-pressure line BP₃ comprises firstly the first outlet S₁, the refrigeration fluid/ambient air heat exchanger 17, the eighth inlet E₈, the eighth channel C₈ provided with the sixth shutter V₆ and the fourth outlet S₄, and secondly the second outlet S₂, the refrigeration fluid/heat transfer liquid heat exchanger 14, the ninth inlet E₉, the third pressure reduction member D₃ and the fourth outlet S₄, and then the accumulator 16 and the low-pressure channel 21 of the internal heat exchanger 19 in order to end up at the compressor 15.

The first pressure reduction member D₁, the second pressure reduction member D₂ and the third pressure reduction member D₃ form an integral part of the distribution unit according to the invention and are installed inside the latter.

The first valve V′₁, the first shutter V₁, the second valve V′₂, the second shutter V₂, the third shutter V₃, the fourth shutter V₄, the fifth shutter V₅, the sixth shutter V₆, the third valve V′₃ and the seventh shutter V₇ form an integral part of the distribution unit according to the invention and are installed inside the latter.

1. A distribution unit (22) able to manage the circulation of a refrigerating fluid FR within an air conditioning loop (4), the distribution unit (22) comprising a plurality of inlets E₁, E₂, E₃, E₄, E₅, E₆, E₇, E₈, E₉ for refrigerating fluid FR into the distribution unit (22), and a plurality of outlets S₁, S₂, S₃, S₄ for refrigerating fluid FR out of the distribution unit (22), characterised in that each outlet S₁, S₂, S₃, S₄ is in fluid connection with at least two inlets E₁, E₂, E₃, E₄, E₅, E₆, E₇, E₈, E₉.

2. A distribution unit (22) according to claim 1, characterised in that the distribution unit (22) comprises nine inlets E₁, E₂, E₃, E₄, E₅, E₆, E₇, E₈, E₉ and four outlets S₁, S₂, S₃, S₄.

3. A distribution unit (22) according to claim 1, characterised in that a first outlet S₁ is in fluid connection with a first inlet E₁ and a second inlet E₂.

4. A distribution unit (22) according to claim 3, characterised in that the first outlet S₁ is in fluid connection with the first inlet E₁ by a first channel C₁, which is provided with a first pressure reduction member D₁.

5. A distribution unit (22) according to claim 4, characterised in that the first pressure reduction member D₁ is an electronically controlled pressure reduction device.

6. A distribution unit (22) according to claim 4, characterised in that the first channel C₁ is equipped with a first valve V′₁.

7. A distribution unit (22) according to claim 3, characterised in that the first outlet S₁ is in fluid connection with the second inlet E₂ by a second channel C₂, which is provided with a first shutter V₁.

8. A distribution unit (22) according to claim 3, characterised in that the first outlet S₁, the first inlet E₁, the second inlet E₂, the first channel C₁, the second channel C₂, the first shutter V₁, the first valve V′₁ and the first pressure reduction member D₁ constitute a first subassembly SE₁.

9. A distribution unit (22) according to claim 1, characterised in that a second outlet S₂ is in fluid connection with a third inlet E₃ and a fourth inlet E₄.

10. A distribution unit (22) according to claim 9, characterised in that the second outlet S₂ is in fluid connection with the third inlet E₃ by a third channel C₃, which is provided with a second pressure reduction member D₂.

11. A distribution unit (22) according to claim 10, characterised in that the second pressure reduction member D₂ is an electronically controlled pressure reduction device.

12. A distribution unit (22) according to claim 10, characterised in that the third channel C₃ is equipped with a second valve V′₂.

13. A distribution unit (22) according to claim 9, characterised in that the second outlet S₂ is in fluid connection with the fourth inlet E₄ by a fourth channel C₄, which is provided with a second shutter V₂.

14. A distribution unit (22) according to claim 9, characterised in that the second outlet S₂, the third inlet E₃, the fourth inlet E₄, the third channel C₃, the fourth channel C₄, the second valve V′₂, the second shutter V₂ and the second pressure reduction member D₂ constitute a second subassembly SE₂.

15. A distribution unit (22) according to claim 1, characterised in that a third outlet S₃ is in fluid connection with a fifth inlet E₅, a sixth inlet E₆ and a seventh inlet E₇.

16. A distribution unit (22) according to claim 15, characterised in that the third outlet S₃ is in fluid connection with the fifth inlet E₅ by a fifth channel C₅, which is provided with a third shutter V₃.

17. A distribution unit (22) according to claim 15, characterised in that the third outlet S₃ is in fluid connection with the sixth inlet E₆ by a sixth channel C₆, which is provided with a fourth shutter V₄.

18. A distribution unit (22) according to claim 15, characterised in that the third outlet S₃ is in fluid connection with the seventh inlet E₇ by a seventh channel (C₇), which is provided with a fifth shutter V₅.

19. A distribution unit (22) according to claim 15, characterised in that the third outlet S₃, the fifth inlet E₅, the sixth inlet E₆, the seventh inlet E₇, the fifth channel C₅, the sixth channel C₆, the seventh channel C₇, the third shutter V₃, the fourth shutter V₄ and the fifth shutter V₅ constitute a third subassembly SE₃.

20. A distribution unit (22) according to claim 1, characterised in that a fourth outlet S₄ is in fluid connection with an eighth inlet E₈ and a ninth inlet E₉.

21. A distribution unit (22) according to claim 20, characterised in that the fourth outlet S₄ is in fluid connection with the eighth inlet E₈ by an eighth channel C₈, which is provided with a sixth shutter V₆.

22. A distribution unit (22) according to claim 20, characterised in that the fourth outlet S₄ is in fluid connection with the ninth inlet E₉ by a ninth channel C₉ which is provided with a third pressure reduction member D₃.

23. A distribution unit (22) according to claim 22, characterised in that the third pressure reduction member D₃ is an electronically controlled pressure reduction device.

24. A distribution unit (22) according to claim 22, characterised in that the ninth channel C₉ is equipped with a third valve V′₃.

25. A distribution unit (22) according to claim 24, characterised in that a seventh shutter V₇ is disposed in parallel to the third pressure reduction member D₃ and the third valve V′₃.

26. A distribution unit (22) according to claim 20, characterised in that the fourth outlet S₄, the eighth inlet E₈, the ninth inlet E₉, the eighth channel C₈, the ninth channel C₉, the sixth shutter V₆, the seventh shutter V₇, the third valve V′₃ and the third pressure reduction member D₃ constitute a fourth subassembly SE₄.

27. (canceled)

28. An air conditioning loop (4) comprising a distribution unit (22) according to claim 1.

29. An air conditioning loop (4) according to claim 28, characterised in that the air conditioning loop (4) further comprises a refrigerating fluid/heat transfer fluid heat exchanger (13), a refrigerating fluid/heat transfer liquid heat exchanger (14), a refrigerating fluid/ambient air heat exchanger (17), an internal heat exchanger (19), a compressor (15) and an accumulator (16).

30. An air conditioning loop (4) according to claim 29, characterised in that the refrigerating fluid/ambient air heat exchanger (17) comprises a discharge orifice (23) for refrigerating fluid FR that is in fluid connection with the seventh inlet E₇ and the eighth inlet E₈.

31. An air conditioning loop (4) according to claim 29, characterised in that the refrigerating fluid/ambient air heat exchanger (17) comprises an inlet orifice (24) for refrigerating fluid FR that is in fluid connection with the first outlet S₁.

32. An air conditioning loop (4) according to claim 29, characterised in that the refrigerating fluid/heat transfer liquid heat exchanger (14) comprises an outlet orifice (25) for refrigerating fluid FR that is in fluid connection with the sixth inlet E₆ and the ninth inlet E₉.

33. An air conditioning loop (4) according to claim 29, characterised in that the refrigerating fluid/heat transfer liquid heat exchanger (14) comprises an inlet orifice (26) for refrigerating fluid FR that is in fluid connection with the second outlet S₂.

34. An air conditioning loop (4) according to claim 29, characterised in that the internal heat exchanger (19) comprises a high-pressure outlet (27) that is in fluid connection with the first inlet E₁ and the third inlet E₃.

35. An air conditioning loop (4) according to claim 29, characterised in that the internal heat exchanger (19) comprises a high-pressure inlet (28) that is in fluid connection with the third outlet S₃.

36. An air conditioning loop (4) according to claim 29, characterised in that the internal heat exchanger (19) comprises a low-pressure outlet (29) that is in fluid connection with an inlet for admitting refrigerating fluid FR within the compressor (15).

37. An air conditioning loop (4) according to claim 29, characterised in that the internal heat exchanger (19) comprises a low-pressure inlet (30) that is in fluid connection with an outlet discharging refrigerating fluid FR out of the accumulator (16).

38. An air conditioning loop (4) according to claim 29, characterised in that the accumulator (16) comprises an inlet orifice (31) for refrigerating fluid FR that is in fluid connection with the outlet S₄.

39. An air conditioning loop (4) according to claim 29, characterised in that the refrigerating fluid/heat transfer fluid heat exchanger (13) comprises a reception opening (38) for the refrigerating fluid FR that is in fluid connection with the compressor (15).

40. An air conditioning loop (4) according to claim 29, characterised in that the refrigerating fluid/heat transfer fluid heat exchanger (13) comprises an opening (39) for discharging refrigerating fluid FR to the second inlet E₂, the fourth inlet E₄ and the fifth inlet E₅.

41. An air conditioning loop (4) according to claim 30, characterised in that the air conditioning loop (4) comprises at least any one of five three-way valves (33, 34, 35, 36, 37), including:
a first three-way valve (33) that is interposed between the refrigerating fluid/heat transfer fluid heat exchanger (13), the fifth inlet E₅, the fourth inlet E₄ and the second inlet E₂,
a second three-way valve (34) that is interposed between the first three-way valve (33), the fourth inlet E₄ and the second inlet E₂,
a third three-way valve (35) that is interposed between the orifice (23) for discharging refrigerating fluid FR out of the refrigerating fluid/ambient air heat exchanger (17), the seventh inlet E₇ and the eighth inlet E₈,
a fourth three-way valve (36) that is interposed between the orifice (25) discharging refrigerating fluid FR out of the refrigerating fluid/heat transfer liquid heat exchanger (14), the sixth inlet E₆ and the ninth inlet E₉,
a fifth three-way valve (37) that is interposed between the high-pressure outlet (27) discharging refrigerating fluid FR out of the internal heat exchanger (19), the first inlet E₁ and the third inlet E₃.
